(19) United States
(12) Patent Application Publication
(10) Pub. No.: US 2016/0041977 A1
(43) Pub. Date: Feb. 11, 2016

(54) STORING METHOD FOR EDITED IMAGE FILE

(71) Applicants: XYZPRINTING, INC., New Taipei City (TW); KINPO ELECTRONICS, INC., New Taipei City (TW); CAL-COMP ELECTRONICS & COMMUNICATIONS COMPANY LIMITED, New Taipei City (TW)

(72) Inventors: KWAN HO, NEW TAIPEI CITY (TW); YU-CHUAN CHANG, NEW TAIPEI CITY (TW)

(21) Appl. No.: 14/510,256

(22) Filed: Oct. 9, 2014

(30) Foreign Application Priority Data
Aug. 5, 2014 (TW) 103126823

(51) Int. Cl. G06F 17/30; G06F 3/0481; G06F 3/0484

(52) U.S. Cl. CPC G06F 17/3028; G06F 3/04845; G06F 3/04815

(57) ABSTRACT

A storing method temporarily records every editing actions when a 3D-model of an original image file is edited. When the 3D-model is edited completely and an edition-completed model is obtained, a project file is created to store an absolute address of the original image file located in a hard-drive, and to store the temporary recorded editing actions to as a log file of the project file. When the project file is opened later, it opens the 3D-model of the original image file in according to the stored absolute address, and then the opened 3D-model is edited automatically in according to the stored editing actions. Therefore, the edition-completed model can be obtained directly whenever the project file is opened. Also, a user can recover the edition-completed model back to a status before executing any one of the edition actions in according to the log file.

### BACKGROUND OF THE INVENTION

1. Field of the Invention

An exemplary embodiment relates to the processing method of the image file; particularly relates to the storing method for the edited image file.

2. Description of Related Art

Via 3D printing, the real model required by the user can be customized fast, which is rather convenient. In addition, with the development of the 3D printing technology, the 3D printer would cost less and less. Accordingly, in recent years, people have soon been more and more familiar with the 3D printing technology in their daily lives.

The current 3D printer prints the corresponding real model according to the 3D-model edited or imported by the editing software. Generally speaking, an edition-completed 3D-model is consisted of several independent 3D-models. It is worth mentioning that, no matter how many 3D-models are imported into an image file, after the image file has been stored and opened again, the several 3D-models in the image file would be considered a whole 3D-model by the editing software. In other words, there is no longer boundaries between the 3D-models, and thus the user cannot respectively edit the several 3D-models in the image file.

From the above, in the prior art, the user cannot respectively edit the several 3D-models in the image file that has been stored and opened again. Thus, if the user wants to respectively edit the several 3D-models, he can only build a new image file, import the several 3D-models again, respectively edit the several 3D-models, and save the image file again, which is rather bothersome.

In addition, in the prior art, after the user opens the above image file again, he cannot see what editing actions have been executed for the 3D-model in the image file, and thus he absolutely cannot cancel those edition actions to return the 3D-model to a status before certain editing action has been executed, which gives little flexibility to the editing process.

### SUMMARY OF THE INVENTION

An exemplary embodiment has provided a storing method for edited image file. Via the exemplary embodiment, after an edition-completed and stored file has been opened again, one or several 3D-models thereof could be edited respectively still.

In the exemplary embodiment, after an edition-completed and stored file has been opened, the 3D-model thereof could be returned to a status before any editing action has been executed.

In the exemplary embodiment, each editing action is temporarily stored when the 3D-model in an original image file is edited, and the original image file would be stored in a storing medium as a project file when storing the edition-completed 3D-model, such as an absolute address in a hard-drive. Also, each edition action is stored as a log file in the project file sequentially in the project file. When the project file is opened, the corresponding 3D-model in the original file is opened according to the absolute address, and the 3D-model is edited automatically according to each editing action in the log file. Thus, the edition-completed 3D-model could be directly obtained, and the user can return the 3D-model back to a status before certain editing action has been executed according to the log file if he'd like to.

Comparing with the prior art, in the exemplary embodiment, a plurality of original files that the user wants to edit could be connected via the project file, and the user's editing actions executed for the 3D-model in the original files would be recorded. Thus, after the project file is opened, the edition-completed 3D-model could be directly completed. In addition, by the log file in the project file, the user could return the edition-completed 3D-model back to a status before certain editing action has been executed if he'd like to. Therefore, it would be more flexible to edit the 3D-model.

### BRIEF DESCRIPTION OF THE DRAWINGS

Embodiments are illustrated by way of example and not by way of limitation in the figures of the accompanying drawings, in which like references indicate similar elements and in which:

FIG. 1 is a flow chart for storing a project file according to the first exemplary embodiment.

FIG. 2 is a flow chart for opening a project file according to the first exemplary embodiment.

FIG. 3A is a schematic drawing of the first editing action according to the first exemplary embodiment.

FIG. 3B is a schematic drawing of the second editing action according to the first exemplary embodiment.

FIG. 3C is a schematic drawing of the third editing action according to the first exemplary embodiment.

FIG. 3D is a schematic drawing of the fourth editing action according to the first exemplary embodiment.

FIG. 4 is an operation flow chart according to the first exemplary embodiment.

FIG. 5 is a schematic drawing of the undo interface according to the first exemplary embodiment.

FIG. 6 is a schematic drawing of the undo interface according to the second exemplary embodiment.

FIG. 7 is a schematic drawing of the undo interface according to the third exemplary embodiment.

FIG. 8 is a flow chart for undoing according to the first exemplary embodiment.

FIG. 9 is a flow chart for undoing according to the second exemplary embodiment.

FIG. 10 is a flow chart for undoing according to the third exemplary embodiment.

### DETAILED DESCRIPTION OF PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

Based on a preferred exemplary embodiment, it is described with figures as below.

The present has disclosed a storing method for edited image file. To execute the storing method, an editing software (not shown) needs to be installed in the user's computer and be opened. To be concrete, the computer needs to be equipped with a storing medium and the editing software is installed in the storing medium. Also, the 3D-models in the image file edited by the user via the editing software is stored in the storing medium. In the following description, a hard-drive is taken as an example of the storing medium; however, in other embodiments, the storing medium could also be a flash drive, a memory card or a rewritable disk, so it is not limited thereto.

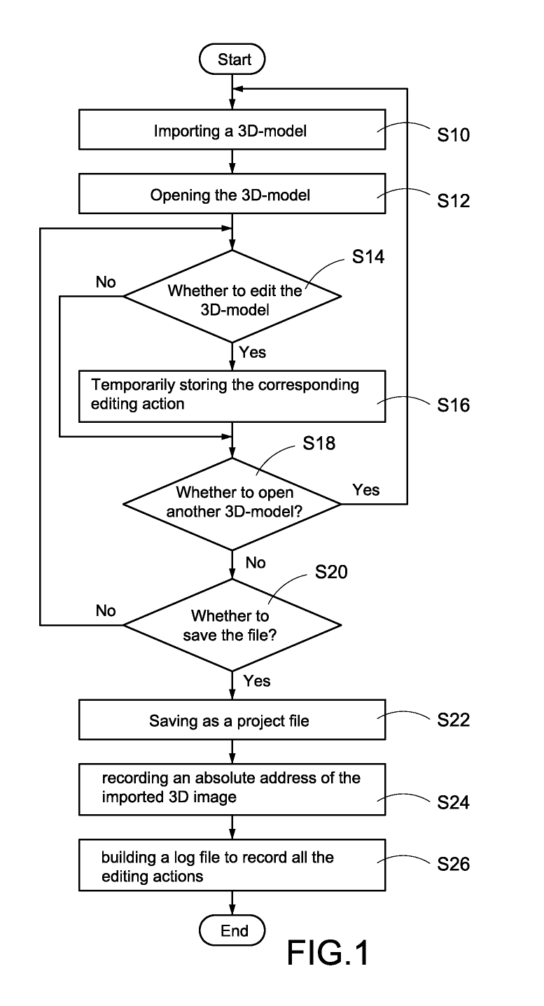

Please refer to FIG. 1, FIG. 1 is a flow chart for storing a project file according to the first exemplary embodiment. In this embodiment, the user operates the editing software so as to build or import an image file (Step S10). When a new image file is built, the user can edit a new 3D-model in the 3D image file; when importing an existed image file, the editing software can open the 3D-model in the image file after the the image file is imported (Step S12). In this embodiment, a file with “.STL” as its extension is taken for an example as the image file, but it is not limited thereto. For the ease of explanation, the description is based on the situation when the existed image file is imported, but it is not limited thereto.

The editing software determines whether the user has edited the opened 3D-model (Step S14). The edition actions refer to move, rotate, or zoom the 3D-model, but it is not limited thereto. If the user has actually edited the 3D-model, the editing software would not only adjust the 3D-model according to the editing action but also temporarily store the corresponding editing action at the same time (Step S16).

The editing software can simultaneously determine whether the user imports another image file and whether the user opens another 3D-model in another image file (Step S18). If yes, the steps S10˜S16 would be executed repeatedly. It is worth mentioning that, if another 3D-model has been opened, the “editing” described in the step S14 refers to the editing action made for any of the above 3D-models. In addition, the step S14 and the step S18 can be executed at the same time, and the executing sequence is not limited.

After that, the editing software determines whether the user has done his edition and needs to save the file (Step S20). In this embodiment, when the editing software receives a storing instruction, it is determined that the file should be saved. If the user has not yet completed his edition, the steps S14˜S18 would be executed repeatedly, so as to continue to edit the 3D-model and import other image files. If the user has completed his edition and needs to save the file, the editing software would save the edition-completed 3D-model as a project file (Step S22).

In this embodiment, the project file records all image files imported into the editing software with the absolute addresses in the hard-drive (Step S24), and builds a log file to record all editing actions temporarily stored by the editing software (Step S26), wherein the editing actions are recorded according to the executing sequence.

In other words, in the exemplary embodiment, the storing method does not save the edition-completed 3D-model as a new image file (for example, the above mention file with the “.STL” as its extension) but a project file.

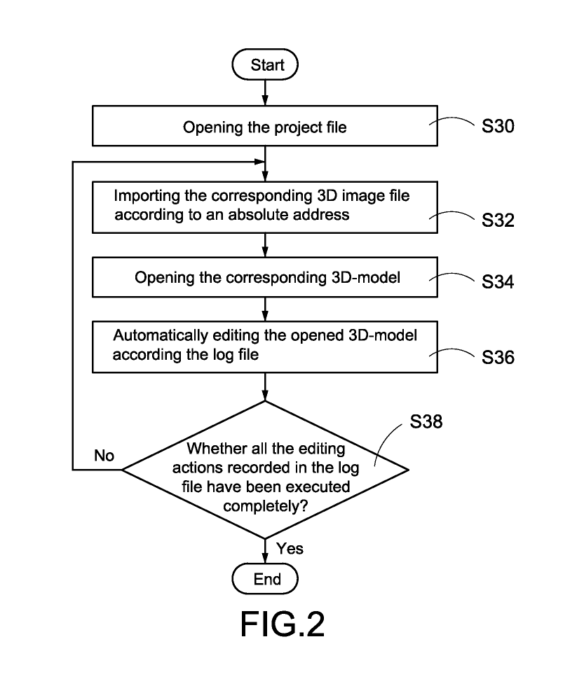

Please refer to FIG. 2, FIG. 2 is a flow chart for opening a project file according to the first exemplary embodiment. When the user wants to open the edition-completed 3D-model, he can open its project file via the editing software (Step S30). After the project file is opened, the editing software can obtain one or several absolute addresses recorded in the project file, and import one or several corresponding image files according to the one or several absolute addresses (Step S32). After the image files are imported, one or several corresponding 3D-models can be opened (Step S34). It is worth mentioning that, the one or several 3D-models opened at this moment are original models that have not yet been edited.

After that, the editing software further automatically edits the one or several opened 3D-models, according to the one or more editing actions in the project file recorded by the log file (Step S36). The editing software determines whether all the editing actions recorded in the log file have already been executed completely (Step S38). If not, the steps S32˜S36 would be repeatedly executed so as to import all image files and complete the editing action for all of the 3D-models. If all of the editing actions recorded in the log file have been already executed completely, the user can obtain the last edition-completed 3D-model.

It is worth mentioning that, the edition-completed 3D-model is not saved as an independent image file, so if the edition-completed 3D-model is comprised of several 3D-models, the user can respectively edit the several 3D-models still.

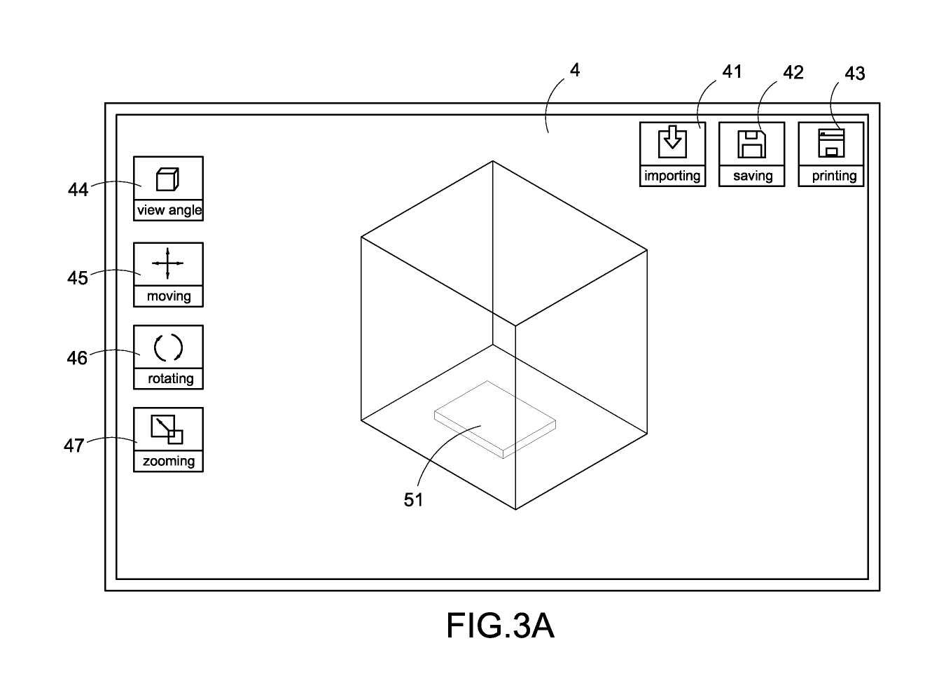

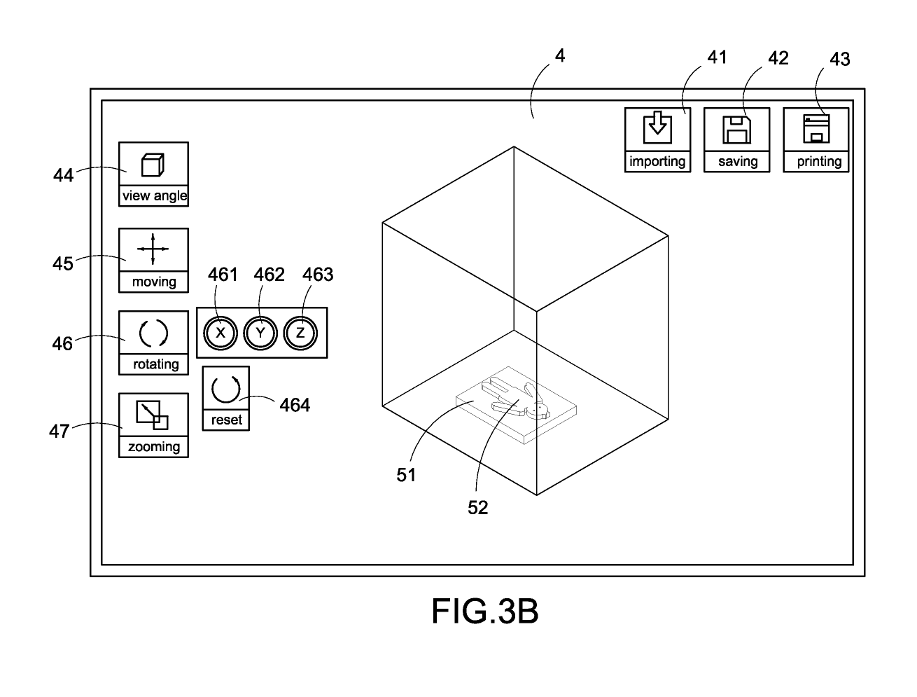

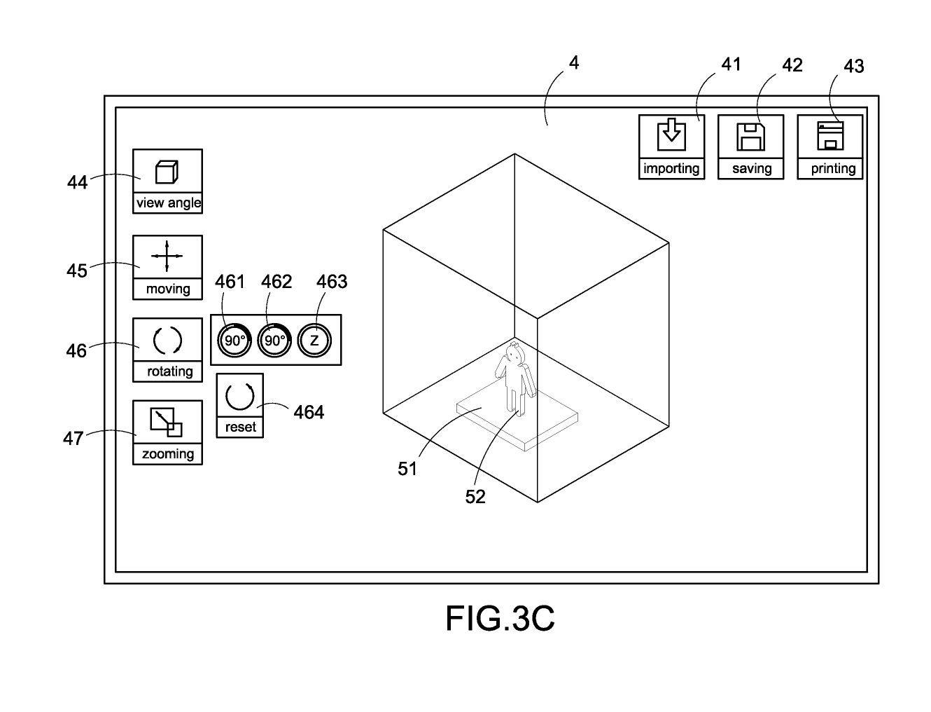

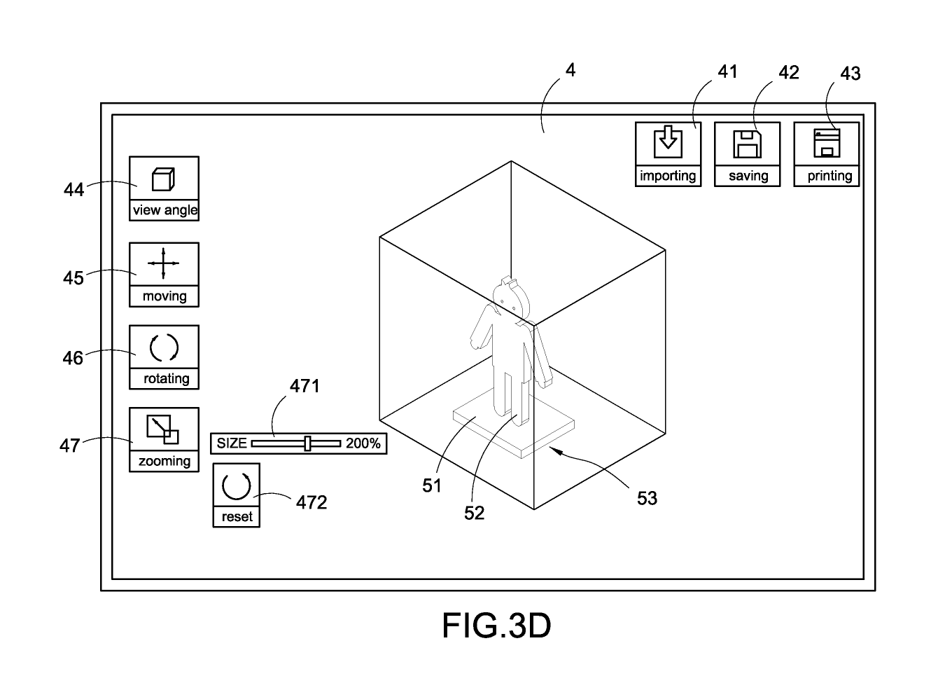

Please refer to FIGS. 3A˜3D, FIGS. 3A˜3D are a schematic drawings of the first, second, third and fourth editing actions according to the first exemplary embodiment. As shown in the figures, after executing the editing software, the user can operate an editing page 4 of the editing software, and edit the 3D-model via the editing page 4.

As shown in FIG. 3A, the editing page mainly comprises an importing interface 41, a storing interface 42, a printing interface 43, an angle adjusting interface 44, a moving interface 45, a rotating interface 46 and a zooming interface 47. However, the above is merely one of the preferred exemplary embodiment, the editing page 4 can also provide other operation interfaces which are herein not listed depending on the user's needs.

Via the importing interface 41, the editing software can import an image file so as to open the 3D-model in the image file. In the embodiment shown by FIG. 3A, for example, it is to import a first image file and to open a first model 51, but it is not limited thereto.

Via the storing interface 42, the editing software can save the first model 51 when receiving a storing instruction. It is worth mentioning that, the user can choose to save the first model 51 as an independent image file, or choose to save it as a project file. Via the printing interface 43, the editing software can output the edition-completed first model 51. Thereby, a 3D printer (not shown) connecting with the editing software can print a corresponding real model according to the edition-completed first model 51.

Via the angle adjusting interface 44, the user can adjust the view angle in the editing page 4, so as to check and edit the first model 51. Via the moving interface 45, the user can edit angles of the first model 51 with respect to three axes, and via the zooming interface 47, the user can edit the size of the first model 51.

As shown in FIG. 3B, the user can trigger the importing interface 41 so as to import a second image file and open a second model 52 in the second image file. It is worth mentioning that, if the user saves the first model 51 and the second model 52 as an independent image file via the storing interface 42, this image file would include a third model consisted of the first model 51 and the second model 52. However, the first model 51 and the second model 52 in the third model 53 would no longer have their boundaries, and thus the user can't edit the first model 51 and the second model 52 respectively but can only edit the third model.

In the embodiment shown in the FIG. 3B, the user edits the second model 52 via the rotating interface 46. The rotating interface 46 includes a X-axis rotating button 461, a Y-axis rotating button 462, a Z-axis rotating button 463 and an reset button 464. The X-axis rotating button 461, the Y-axis rotating button 462 and the Z-axis rotating button 463 are respectively used to edit angles of the second model 52 with respect to the three axes. The reset button 464 is used to cancel the editing action of the user, so as to return the second model 52 to a status before rotating.

As shown in FIG. 3C, the user edits the angle of the second model 52 with respect to the X-axis as 90° via the X-axis rotating button 461, and edits the angle of the second model 52 with respect to the Y-axis as 90° via the Y-axis rotating button 462. In this embodiment, the editing software would temporarily store an editing action that “+90° with respect to X-axis of the second model” and an editing action that “+90° with respect to Y-axis of the second model”.

Also, as shown in FIG. 3D, the user edits the size of the second 52 via the zooming interface 47. The zooming interface 47 comprises a size adjusting button 471 and a reset button 472. The size button 471 is for the user to adjust the size of the second model 52, and the reset button 472 is for the user to cancel the editing action, so as to return the second model 52 back to a status before zooming.

In the embodiment shown in FIG. 3D, the user has the size of the second model 52 zoomed to 200%, that is, being twice the size of the original one. In this embodiment, the editing software would temporarily store an editing action of “twice the size of the second model”.

An edition-completed model 53 would be consisted of the edited first model 51 and the edited second model 52. If the user saves the edition-completed model 53 as an independent image file, and when this image file is re-opened the editing software would consider the edition-completed model 53 an independent 3D-model. Thus, the user can only edit the edition-completed model 53 as a whole, and cannot respectively edit the first model 51 or the second model 52 included in the edition-completed model 53.

The storing method of the exemplary embodiment is to save the edition-completed model 53 as the project file. The project file mainly stores: 1) the absolute address of the original file of the first model 51 in the hard-drive; 2) the absolute address of the original file of the second model 52 in the hard-drive; and 3) the three edition actions sequentially executed on the first model 51 and the second model 52. In other words, the project file is not to directly save the edition-completed model 53 but the original files of the first model 51, the second model 52 and the edition actions sequentially executed on the first model 51 and the second model 52.

In each step shown in FIG. 2, when the user opens the project file, it is to import the original file via the absolute address recorded by the project file and to open the 3D-model in the original image file. After that, the 3D-model is automatically edited according to the log file, so as to automatically obtain the edition-completed 3D-model. Accordingly, in this embodiment, the user can choose several editing actions recorded in the log file so as to return the edition-completed 3D-model back to a status before certain edition action is executed.

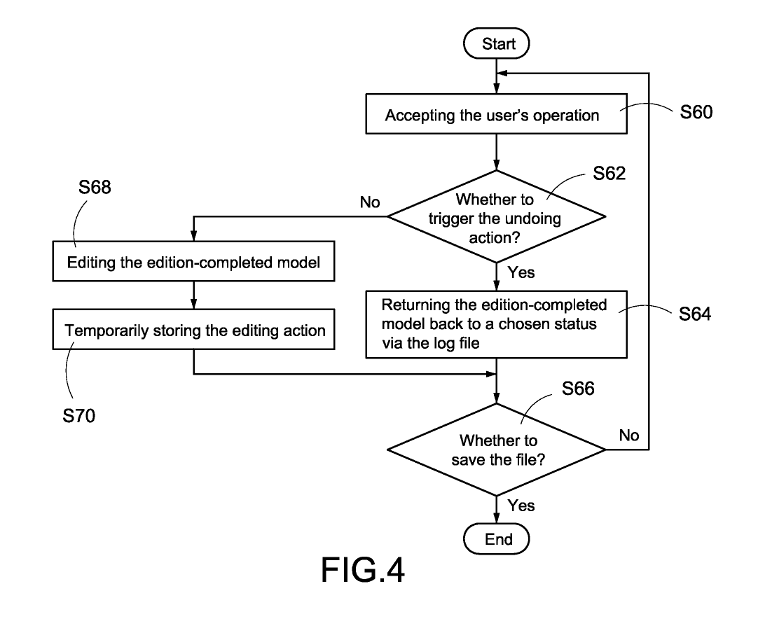

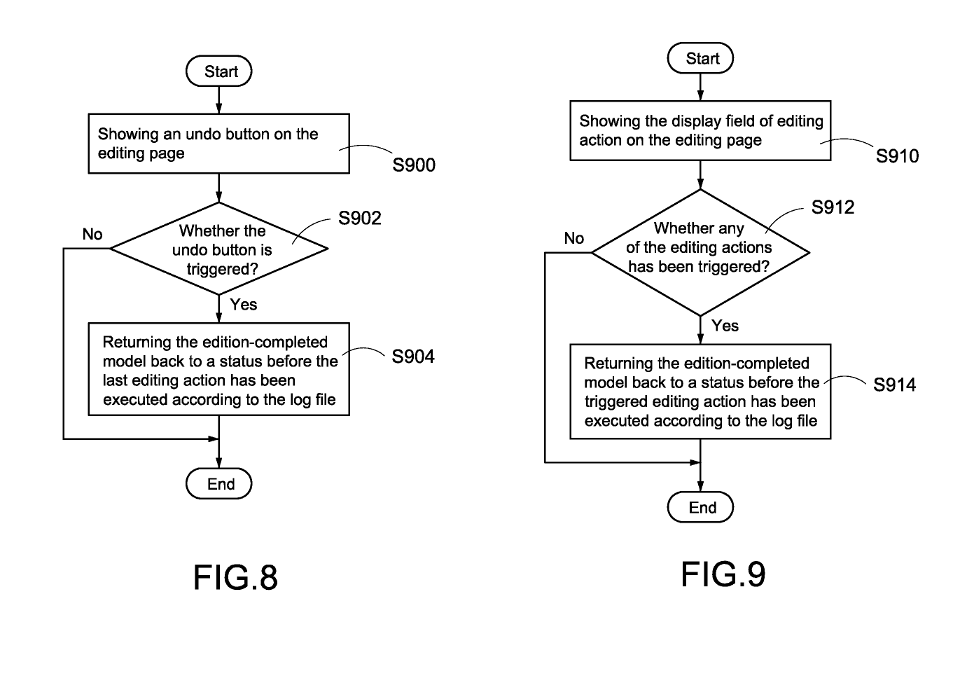

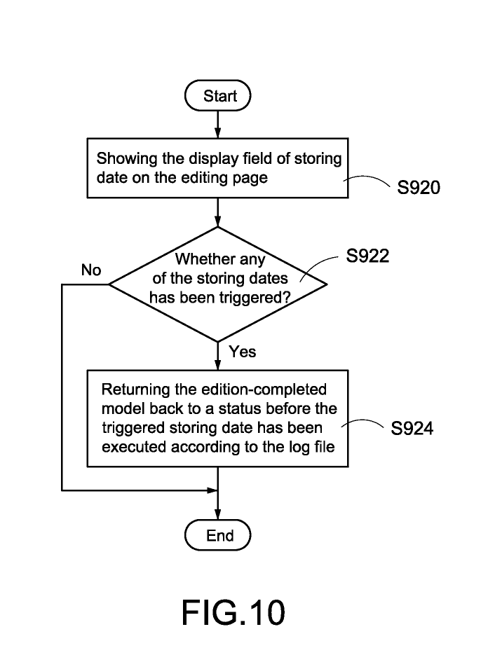

The exemplary embodiment further discloses an undoing method for the edition action of the edited image file. Please refer to FIG. 4, FIG. 4 is an operation flow chart according to the first exemplary embodiment. After the user opens the project file and obtains the edition-completed model 53, the editing software would accept the user's operation (Step S60) and determine whether the user's operation triggers an undo action (Step S62). If yes, the editing software executes the undoing step for the editing action shown in FIG. 8, FIG. 9 and FIG. 10 according to the undoing action triggered by the user. To be concrete, the editing software returns the edition-completed model 53 back to a status chosen by the user according the log file (Step S64). After that, the editing software determines whether the user has finished his edition and wants to save the file (Step S66). If yes, the edition-completed model is saved as a project file, and if not, it returns back to the step S60 and the editing software continues to accept the user's operation.

In the step S62, the editing software determines whether the user has triggered the undoing action, and the editing software can still accept the user's editing on the edition-completed model 53 (Step S68) and further temporarily store the editing action (Step S70). Thus, when the user wants to save the project file, the log file in the project file would be updated.

To be more concrete, the edition action temporarily stored by the editing software in the step S70 would be added into the log file of the project file. Thus, next time when the user opens the project file, he can directly obtain the edition-completed model 53 after the step S68. In this embodiment, the edition action executed for the edition-completed model 53 in the step S68 may be the editing action executed merely for the first model 51, merely for the second model 52 or may be the editing action executed for the edition-completed model 53.

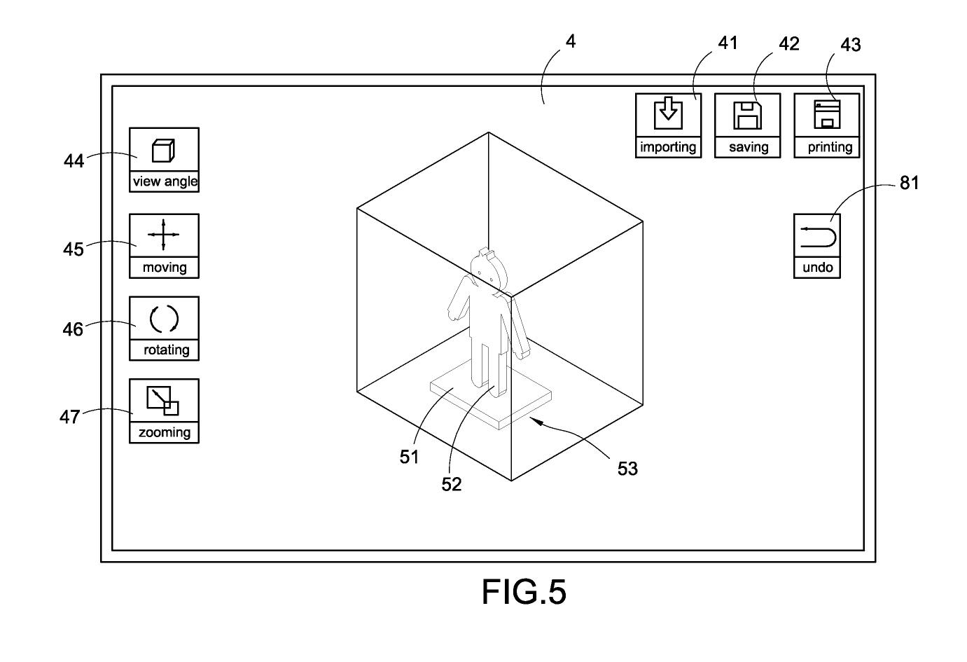

Please refer to FIG. 5, FIG. 5 is a schematic drawing of the undo interface according to the first exemplary embodiment. After the editing software opens the project file, there would be an undo button (UNDO) 81 shown in the editing page 4. When the undo button 81 is triggered, the editing software returns the edition-completed model 53 back to a status before the last editing action has been executed according to the log file of the project file. Take the embodiments shown in FIGS. 3A˜3D as examples, when the undo button 81 has been triggered once, the second model 52 in the edition-completed model 53 would return to a status before zooming to 200%. When the undo button 81 has been triggered twice, the second model 52 in the edition-completed model 53 would return to a status before having a rotation of 90° with respect to the Y-axis, and so on.

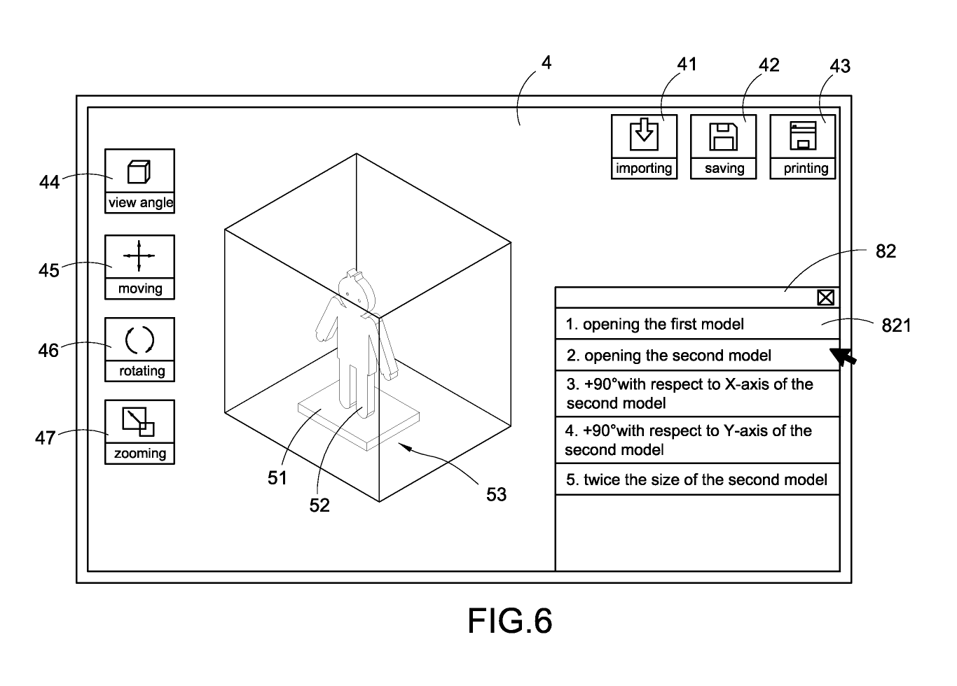

Please refer to FIG. 6, FIG. 6 is a schematic drawing of the undo interface according to the second exemplary embodiment. There is also a display field 82 of the editing action shown in the editing page 4 and several editing actions 821 recorded in the log file would be listed sequentially in the display field 82 of the editing action. When any of the editing actions 821 listed in the display field 82 of the editing action is chosen, the editing software automatically returns the edition-completed model 53 back to a status before the chosen editing action 821 has been executed.

For example, if the user chooses the editing action 821 which is “importing the second model”, and the editing software would return the edition-completed model 53 back to a status when the first model 51 has not yet been edited and when the second model 52 has not yet been opened.

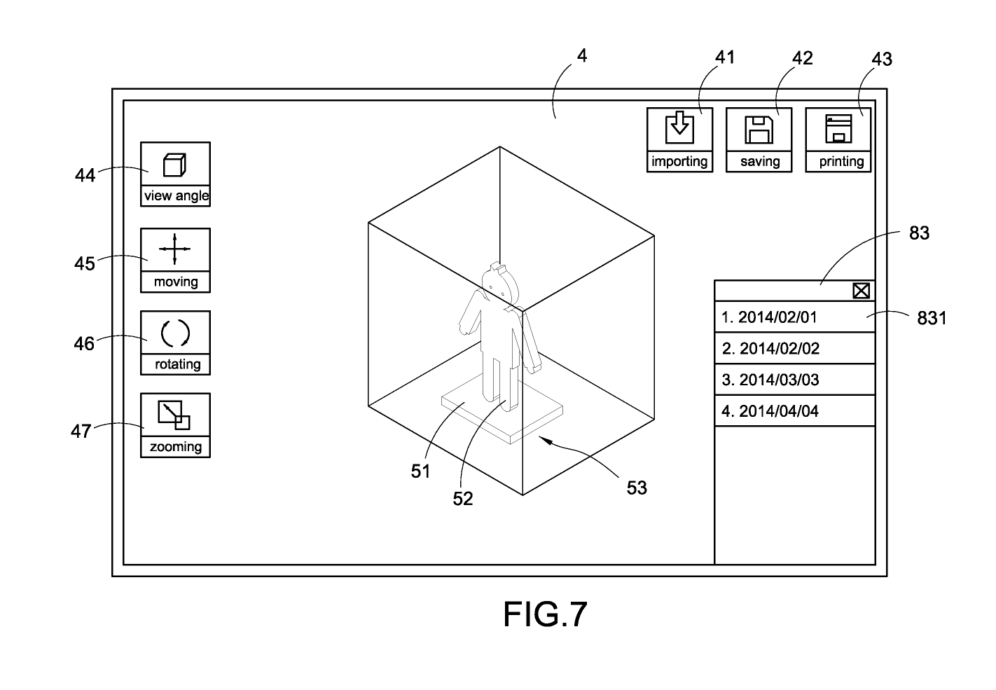

Please refer to FIG. 7, FIG. 7 is a schematic drawing of the undo interface according to the third exemplary embodiment. A display field 83 of the storing date can also show in the editing page 4, and several storing dates 831 stored in the project file would be listed sequentially in the display field 83 of the storing date. When any storing date 831 listed in the display field 83 of the storing date has been chosen, the editing software automatically returns the edition-completed model 53 back to a status on the chosen storing date 831.

For example, if the user chooses the storing date 831 which is “2014/03/03”, and the editing software would return the edition-completed model 53 back to a status stored after the edition was completed on Mar. 3, 2014.

Please refer to FIG. 8, FIG. 8 is a flow chart for undoing according to the first exemplary embodiment. After the editing software opens the project file, the undo button would show in the editing page 4 (Step 900). After that, the editing software determines whether the undo button 81 has been triggered (Step 902). If the undo button 81 has actually been triggered, the editing software returns the edition-completed model 53 back to a status before the last editing action has been executed according to the log file of the project file (Step S904). It is worth mentioning that, once the undo button has been triggered, it means to undo one edition action. Thus, if the user wants to undo the three edition actions for the edition-completed model 53, he needs to trigger the undo button 81 for three times. However, it is merely one of the preferred exemplary embodiment, so it is not limited thereto.

Please refer to FIG. 9, FIG. 9 is a flow chart for undoing according to the second exemplary embodiment. After the editing software opens the project file, the display field 82 of editing action would be shown in the editing page 4, and all editing actions 821 recorded in the log file would be listed in the display field 82 of edition action (Step S910). After that, the editing software determines whether any of the editing actions 821 has been triggered (Step 912). If any of the editing actions 821 has been triggered, the editing software returns the edition-completed model 53 back to a status before the triggered editing action has been executed according to the log file (Step S914).

Please refer to FIG. 10, FIG. 10 is a flow chart for undoing according to the third exemplary embodiment. After the editing software opens the project file, the display field 83 of storing date would be shown in the editing page 4, and all storing dates stored in the project file would be listed in the display field 83 of storing date (Step S920). After that, the editing software determines whether any of the storing dates 831 has been triggered (Step S912). If any of the storing date 831 has been triggered, the editing software returns the edition-completed model 53 back to a status on the storing date which has been triggered according to the log file (Step S914).

Via the storing method and the undoing method of the exemplary embodiment, after the user stores a project file and opens it again, he can still respectively edit the several 3D-models comprised in an edition-completed 3D model. Also, the user can returns the edition-completed 3D-model back to a status before certain editing action has been executed if he'd like to. Therefore, comparing with the traditional editing process of 3D-model, much more flexibility would be provided, which further provides much convenience.

It should be understood that the exemplary embodiments described therein should be considered in a descriptive sense only and not for purposes of limitation. Descriptions of features or aspects within each embodiment should typically be considered as available for other similar features or aspects in other embodiments. While one or more exemplary embodiments have been described with reference to the figures, it will be understood by those of ordinary skill in the art that various changes in form and details may be made therein without departing from the spirit and scope of the exemplary embodiment as defined by the following claims.

What is claimed is:

1. A storing method for edited image file, used in an editing software, the editing software installed in a storing medium of a computer, and at least one image file stored in the storing medium, the storing method for edited image file comprising:
a) importing the image file and opening one of 3D-models in the image file;
b) editing the one of the 3D-models and temporarily storing one or several corresponding edition actions; and
c) generating a project file when receiving a storing instruction, wherein the project file records an absolute address of the image file in the storing medium and records a log file that records one or several editing actions stored temporarily in the editing software.

2. The storing method for edited image file of claim 1, wherein the image file has STL as its extension.

3. The storing method for edited image file of claim 1, wherein the editing action comprises at least one of following actions: moving position of the 3D-model, rotating angle of the one of the 3D-models on three axes, and adjusting size of the 3D-model.

4. The storing method for edited image file of claim 1, further comprising:
d1) determining whether to import another image file; and
d2) from the above Step d1), if yes, importing the another image file and opening another of 3D-models in the another image file, wherein the Step b) is editing the 3D-model or the another of 3D models and temporarily store one or several corresponding editing actions, and the Step c) is recording the image file and the another image file simultaneously at an absolute address in the storing medium.

5. The storing method for edited image file of claim 1, after the Step c), further comprising:
e) opening the project file;
f) importing the corresponding image file according to the absolute address recorded in the project file, and opening the one of the 3D-models in the image file; and
g) automatically editing the one or several editing actions correspondingly according to the one or several editing actions recorded in the log file, so as to obtain an edition-completed model.

6. The storing method for edited image file of claim 1, further comprising a plurality of steps for undoing the edition action, which comprises:
h1) opening the project file via the editing software;
h2) importing the corresponding image file according to the absolute address recorded in the project file, and opening the one of the 3D-models in the 3D image file;
h3) automatically editing the 3D-model correspondingly according to the one or several editing actions recorded by the log file in the project file, so as to obtain an edition-completed model; and
h4) accepting an external operation and determining whether an undo action has been triggered.

7. The storing method for edited image file of claim 6, further comprising:
h6) accepting the external operation so as to edit the edition-completed model;
h7) temporarily storing one or several corresponding editing actions; and
h8) adding the one or several editing actions temporarily stored in the Step h7) into the log file when receiving the storing instruction, so as to update the project file.

8. The storing method for edited image file of claim 6, wherein the editing software provides an undo button, and the Step h4) and Step h5) further comprise:
h41) determining whether the undo button has been triggered; and
h51) if the undo button has been triggered, returning the edition-completed model to a status before the last editing action has been executed according to the log file.

9. The storing method for edited image file of claim 6, wherein the editing software provides a display field of editing action, the display field of editing action orderly shows all editing actions recorded by the log file, and the Step h4) and the Step h5) comprises:
h42) determining whether any one editing action shown in the display field of edition action has been triggered; and
h52) if any editing action is triggered, the edition-completed model would be returned to a status before the triggered editing action has been executed according to the log file.

10. The storing method for edited image file of claim 6, wherein the editing software provides a display filed of storing date, the display field of storing date shows all storing dates of the project file sequentially, and the Step h4) and the Step h5) further comprise:
h43) determining whether any of the storing dates in the display field of storing date has been triggered; and
h53) if any of the storing date has been triggered, the edition-completed model would be returned to a status before the triggered editing action has been executed according to the log file.
